(19) United States
(12) Patent Application Publication
(10) Pub. No.: US 2025/0201447 A1
(43) Pub. Date: Jun. 19, 2025

(54) ELECTRIC VEHICLE SUPPLY EQUIPMENT SMART CIRCUIT BREAKER CHARGER SHIELDED WIRING MECHANISMS OR DISTANT INSTALLATION OF EV CHARGING CORD AND HANDLE

(71) Applicant: EATON INTELLIGENT POWER LIMITED, DUBLIN 4 (IE)

(72) Inventors: Thomas A. Kent, Senoia, GA (US); Robert J. Reese, Edwardsville, IL (US)

(73) Assignee: EATON INTELLIGENT POWER LIMITED, DUBLIN 4 (IE)

(21) Appl. No.: 18/969,436

(22) Filed: Dec. 5, 2024

Related U.S. Application Data
(60) Provisional application No. 63/609,509, filed on Dec. 13, 2023.

(51) Int. Cl. H01B 9/02; B60L 53/16; B60L 53/18; B60L 53/30; B60L 53/66; H01B 9/04; H02J 7/00

(52) U.S. Cl. CPC H01B 9/02; B60L 53/18; B60L 53/30; B60L 53/66; H01B 9/04; H02J 7/0029; H02J 7/0042; B60L 53/16

(57) ABSTRACT

An electric vehicle (EV) charging system includes a load panel including an EVSE circuit breaker charger comprising an EV charger structured to supply power to an EV via power conductors, a circuit interrupter structured to interrupt current from flowing to the EV in an event of fault, and a communications component structured to transmit bidirectionally control pilot (CP) communications and control signals between the EVSE circuit breaker charger and the EV via a shielded CP conductor and a ground conductor; an EV charge handle connected to an EV cord; a conduit structured to encase the power conductors, the shielded CP conductor, the ground conductor, and a 12 V DC supply conductor structured to supply power to a status, the conductors being structured to be electrically connected to the EVSE circuit breaker charger at one end and a remote junction box at the other end.

### CROSS-REFERENCE TO RELATED APPLICATION

This patent application claims the priority benefit under 35 U.S.C. § 119 (e) of U.S. Provisional Application No. 63/609,509, filed on Dec. 13, 2023, the contents of which are herein incorporated by reference.

### FIELD OF THE INVENTION

The disclosed concept relates generally to an electric vehicle (EV) charging mechanism, and in particular, to an electric vehicle supply equipment (EVSE) smart circuit breaker charger shielded wiring mechanisms for distant installation of EV charging cord and handle.

### BACKGROUND OF THE INVENTION

An electric vehicle supply equipment (EVSE) may be an EV charging station that can be mounted on a wall or a pedestal for charging an EV. In some examples, an EVSE Smart Breaker Charger (an EV charger built into a miniature circuit breaker form factor) may be placed within a load center or panelboard in a utility room, laundry room, garage, or other appropriate area located remotely from a charging location. Such a remote EVSE Smart Breaker Charger is connected to a distant Junction Box, which in turn is connected to an EVSE charging cord and charging handle via a conduit. Currently, the EVSE Smart Breaker Charger and Junction Box option has a design requirement for greater than 76.2 meters (250 feet) for the installation distance therebetween. However, when an EVSE Smart Breaker Charger is remotely installed at a distance from a Junction Box using a plurality of conductor wires (e.g., without limitation, five) inside a conduit, capacitive coupling between conductors and the conduit and moisture within the conduit create a situation where Control Pilot (CP) conductor communication is severely degraded. For example, the presence of moisture/water in combination with electrical conductors and communication wires creates high levels of added capacitance which disrupts communication between the EVSE Smart Breaker Charger and the connected EV.

There is room for improvement in EV charging.

There is room for improvement in communications and control signals conveyance between a remote EVSE Smart Breaker Charger and a distant Junction Box.

### SUMMARY OF THE INVENTION

These needs, and others, are met by an electric vehicle (EV) charging system. The EV charging system includes a load panel including one or more EV supply equipment (EVSE) circuit breaker charger each comprising an EV charger structured to supply power to an EV via power conductors, a circuit interrupter structured to interrupt current from flowing to the EV in an event of fault, and a communications component structured to transmit bidirectionally control pilot (CP) communications and control signals between the EVSE circuit breaker charger and the EV via a shielded CP conductor and a ground conductor; an EV charge handle connected to an EV cord and structured to connect the EVSE circuit breaker charger to the EV for charging; a conduit structured to encase a plurality of conductors including the power conductors, the shielded CP conductor, the ground conductor, and a 12 V direct current (DC) supply conductor structured to supply power to a status indicator disposed on the EV charge handle, the plurality of conductors being structured to be electrically connected to the EVSE circuit breaker charger at one end and a junction box disposed remotely from the EVSE circuit breaker charger and structured to receive the conduit therein, the junction box including terminal blocks structured to electrically connect the plurality of conductors to the EV charge handle at the other end of the conductors.

Another example embodiment provides a conduit structured to electrically connect an electric vehicle supply equipment (EVSE) circuit breaker charger and a junction box coupled to an EV charge handle. The conduit includes a coaxial cable shielded control pilot (CP) conductor structured to transmit bidirectionally CP communications and control signal between the EVSE circuit breaker charger and an EV; power conductors structured to supply power to charge the EV; a 12 V direct current (DC) supply conductor structured to supply power to a status indicator disposed on the EV charge handle; and a ground conductor structured to provide a return path for the CP communications and control signal, wherein the coaxial cable shielded CP conductor, the power conductors, the 12 V DC supply conductor and the ground conductor are electrically connected to the EVSE circuit breaker charger at one end and terminal blocks of the junction box at the other end, the terminal blocks electrically connecting the coaxial cable shielded CP conductor, the power conductors, the 12 V DC supply conductor and the ground conductor to the EV charge handle coupled to an EV cord.

Yet another example embodiment provides conduit structured to electrically connect an electric vehicle supply equipment (EVSE) circuit breaker charger and a junction box coupled to an EV charge handle. The conduit includes a shielded twisted pair of a control pilot (CP) conductor and a 12 V direct current (DC) supply conductor, the CP conductor being structured to transmit bidirectionally CP communications and control signal between the EVSE circuit breaker charger and an EV, the 12 V DC supply conductor structured to supply power to a status indicator disposed on the EV charge handle; power conductors structured to supply power for charging the EV; and a ground conductor structured to provide a return path for the CP communications and control signal, wherein the shielded twisted pair of the CP conductor and the 12 V DC supply conductor, the power conductors, and the ground conductor are electrically connected to the EVSE circuit breaker charger at one end and terminal blocks of the junction box at the other end, the terminal blocks structured to electrically connect the shielded twisted pair of the CP conductor and the 12 V DC supply conductor, the power conductors and the ground conductor to the EV charge handle coupled to an EV cord.

### BRIEF DESCRIPTION OF THE DRAWINGS

A full understanding of the invention can be gained from the following description of the preferred embodiments when read in conjunction with the accompanying drawings in which:

FIG. 1 is a diagram of an exemplary EVSE charging system in accordance with an example embodiment of the disclosed concept;

FIG. 2 is a diagram of an exemplary EVSE charging system installed at a single-family residence in accordance with an example embodiment of the disclosed concept;

FIG. 3 is a diagram of an exemplary EVSE charging system installed at a multi-family residence or commercial parking lot in accordance with an example embodiment of the disclosed concept;

FIG. 4 illustrates an exemplary EVSE charging system having an EVSE circuit breaker charger installed in a load center (open) electrically connected to a remote Junction Box via a conduit having five conductors in accordance with an example embodiment of the disclosed concept;

FIG. 5 is an enlarged view of Area 1300 illustrating an inner view of an exemplary coaxial cable;

FIG. 6 illustrates an exemplary EVSE charging system having an EVSE circuit breaker charger installed in a load center (closed) electrically connected to a remote Junction Box via a conduit having five conductors including a coaxial cable shielded control pilot (CP) conductor in accordance with an example embodiment of the disclosed concept;

FIG. 6A is an enlarged inner view of the Junction Box of FIG. 6;

FIG. 7 illustrates an exemplary EVSE charging system having an EVSE circuit breaker charger installed in a load center (open) electrically connected to a remote Junction Box via a conduit having five conductors including a shielded twist pair of CP conductor and a 12 V DC supply conductor in accordance with an example embodiment of the disclosed concept;

FIG. 8 illustrates an exemplary shielded twisted pair cable of the EVSE charging system of FIG. 7;

FIG. 9 illustrates a diagram of the exemplary EVSE charging system of FIG. 7 with the closed load center in accordance with an example embodiment of the disclosed concept; and

FIG. 9A is an enlarged inner view of a Junction Box of the EVSE charging system of FIG. 9 in accordance with an example embodiment of the disclosed concept.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

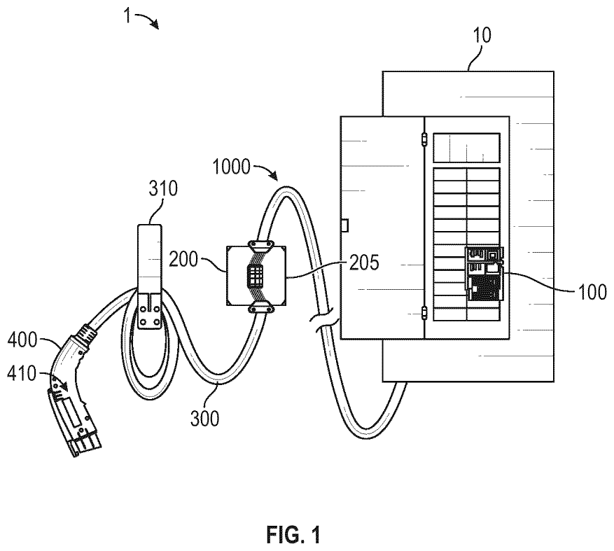

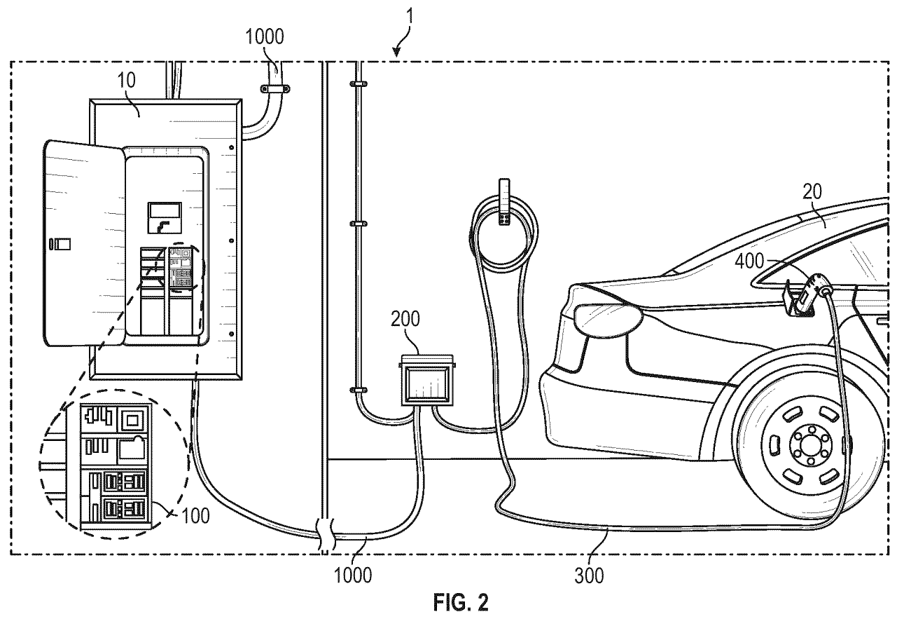

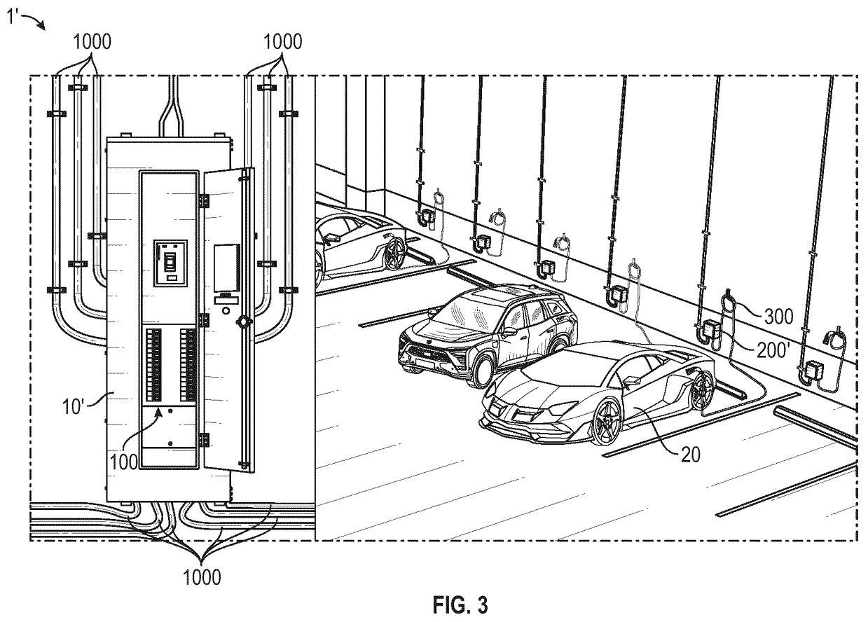

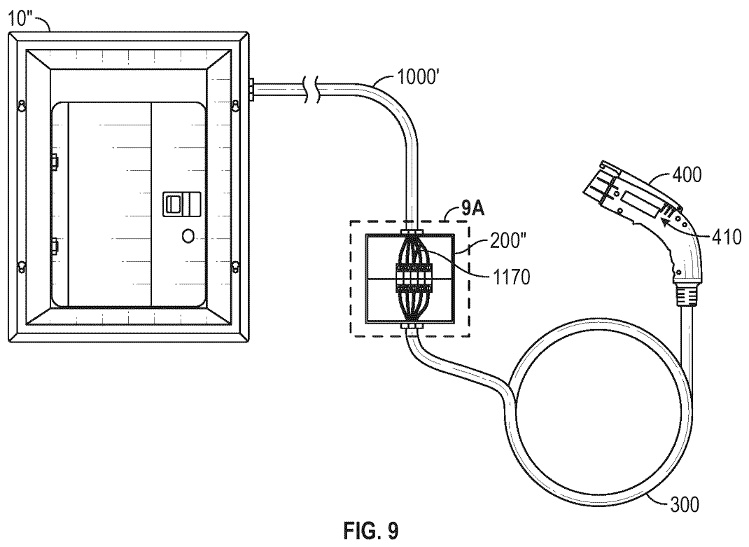

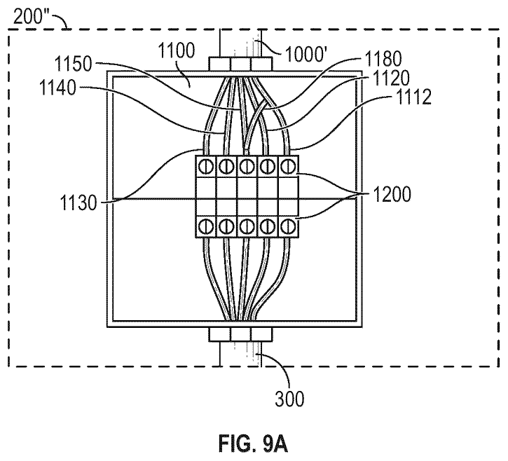

FIGS. 1-9A illustrate an EV charging system 1, 1′, 1″ in accordance with an example embodiment of the disclosed concept. FIG. 1 illustrates an EV charging system 1 including a load panel 10, an EVSE Smart Circuit Breaker Charger 100, a junction box 200 having a terminal block 210, and an EV charging cord 300 connected to an EV connector 400. FIG. 2 illustrates the EV charging system 1 for a single-family residential parking garage. In FIG. 2, the load panel 10 including one or more EVSE Smart Circuit Breaker Chargers 100 is remotely installed in, e.g., without limitation, a laundry room or basement for a single-family residence, and the Junction Box 200 is mounted on a wall of the residential parking garage. FIG. 3 illustrates an EV charging system 1′ for, e.g., without limitation, a multi-family residential, commercial or industrial parking garage. In FIG. 3, the load panel 10′ including a plurality of EVSE Smart Circuit Breaker Charger 100 is installed in, e.g., without limitation, a utility room or an electric room for a commercial or industrial facilities, and the Junction Box 200′ is mounted on a wall of the parking garage.

The EVSE Smart Circuit Breaker Charger 100 is structured to fully incorporate a level two EVSE charging station into the body of a molded case circuit breaker that can be directly mounted into the load panel 10 or panel board. The detailed description of the EVSE Smart Circuit Breaker Charger 100 is included in U.S. Pat. No. 10,427,548, which is incorporated herein by reference in its entirety. Such use of the EVSE Smart Circuit Breaker Charger 100 is unique and novel and represents significant savings in installation costs for multiple charging locations supplied by one or more panel boards (as shown in FIG. 3). The EVSE Smart Circuit Breaker Charger 100 is placeable within a compatible load panel 10 or switchboard, and is structured to provide circuit protection (e.g., interrupting current from flowing in an event of fault) and supply power for charging the EV 20. The EVSE Smart Circuit Breaker Charger 100 is structured to be electrically connected to the Junction Box 200 via a conduit 1000 that extends, e.g., without limitation, overhead, underground, or passing through or around a wall or floor.

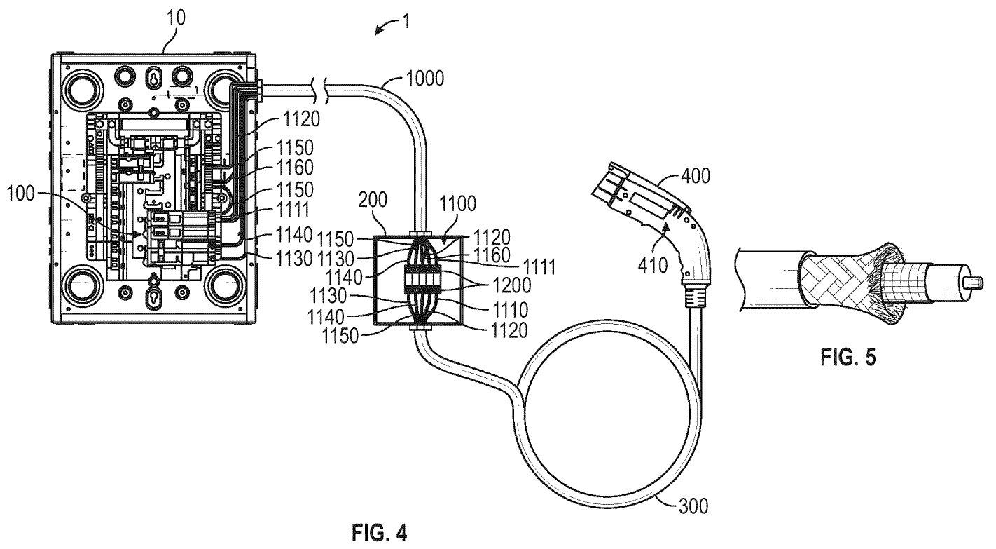

The Junction Box 200,200′ may be any type of switch boxes structured to connect the EVSE Smart Circuit Breaker Charger 100 to the EV charge handle 400 for charging an EV 20. The Junction Box 200,200′ includes a frame 205 and terminal blocks 1200 (see FIGS. 4-9A). The terminal blocks 1200 may be disposed within the frame 205 and structured to connect power, control and communication lines (e.g., without limitations, CP (control pilot), +12V, etc.) between the EVSE Smart Circuit Breaker Charger 100 and the EV charge handle 400. The EV cord 300 is standard multi-wire conductors for EV charging, including the power and communication lines therein. The EV cord 300 may be wound around a holder 310 mounted on the wall when the EV charge handle 400 is not in use. The EV charge handle 400 is a standard EV connector structured to be inserted into a power receptacle of an EV 20. In some examples, the EV charge handle 400 may include an indicator 410, e.g., without limitation, for indicating the EV charging status.

The conduit 1000 may be any type of conduit, e.g., without limitation, a metallic or non-metallic, flexible or rigid, polyvinyl chloride (PVC) or electrical metallic tubing (EMT) conduit. The conduit 1000 is structured to encase a plurality of conductors 1100 that are electrically connected to the EVSE Smart Circuit Breaker Charger 100 and the Junction Box 200,200′ and extended more than 137.16 meter (450 feet) therebetween. The plurality of conductors 1100 may include, e.g., without limitation, L1 conductor 1130 and L2 conductor 1140 which carry the active charging current to the EV 20, ground conductor 1150 which provides the signal return path for the communication and control signal, a control pilot (CP) conductor 1111,1112 which carries the control pilot and communication signals as specified in SAE J1772, and a +12 Vdc supply conductor 1120 which provides power for an LED display 410 in the EV charge handle 400. The L1, L2 and ground conductors 1130,1140,1150 of the disclosed concept are of sufficient gauge and rating to comply with the applicable standards for installation. The signal and current levels for the CP conductor 1111,1112 and +12 Vdc supply conductor 1120 are at a low current level such that voltage drop over distance for conductors of AWG 18 or larger is not a limiting factor for the application.

The control pilot (CP) signals provide the primary control means to ensure proper operation when connecting an EV to an EVSE charger. CP signals include three categories of signals: Resistor logic voltage divider from a DC voltage source, Duty cycle PWM of a 1 kHz square wave, and digital communication per ISO 15118 utilizing a frequency band between 3 MHZ-30 MHz. The CP signals indicate, for example and without limitation, whether an EV is connected (State A), an EV is connected but not ready to accept energy or the EVSE is not ready to supply energy (State B1), an EV is connected but not ready to accept energy while the EVSE is capable of supplying energy (State B2), an EV is connected and ready to accept energy and indoor charging area ventilation is not required while the EVSE is capable of supplying energy (State C), an EV is connected and ready to accept energy and indoor charging area ventilation is required while the EVSE is capable of supplying energy (State D), an EV is disconnected from the EVSE or the EVSE is disconnected from utility or the EVSE loss of utility power or control pilot short to control pilot reference (State E) or other EVSE problem (State F).

However, due to factors that affect the capacitive coupling on the CP conductor, the CP signals may be distorted, and thus the maximum length of the conduit which carries the conductors therein is limited. The physical limitations in allowable distance from the EVSE Smart Breaker Charger to the Junction Box include voltage drop due to wire resistance and signal degradation of the control and communication signals due to coupling capacitance along the CP line to the ground. Indeed, CP line capacitive coupling to the ground is the primary factor in the conduit run length limitation, and thus the limit to the maximum length is determined by the capacitance of the CP line. The maximum capacitance limit is 3,100 pF capacitance according to SAE J1772 standard for the CP line. The limit is due to distortion of 1 kHz square wave duty cycle on the CP line. CP line capacitive coupling is conduit dependent, and thus the factors that affect the amount of capacitive coupling found on the CP wire include the wire gage, selection of conduit type, grounding of the conduit, wire fill and placement in the conduit, and the presence of water in the conduit. For example, it has been shown that non-metallic conduits (e.g., without limitation, PVC) perform better for CP signal communications than the metallic conduits (e.g., without limitation, EMT) do. Further, water in the conduits pauses a serious problem for such communications. Typically, metallic conduits are utilized in EVSE installation in which moisture or water ingress to the conduits is anticipated.

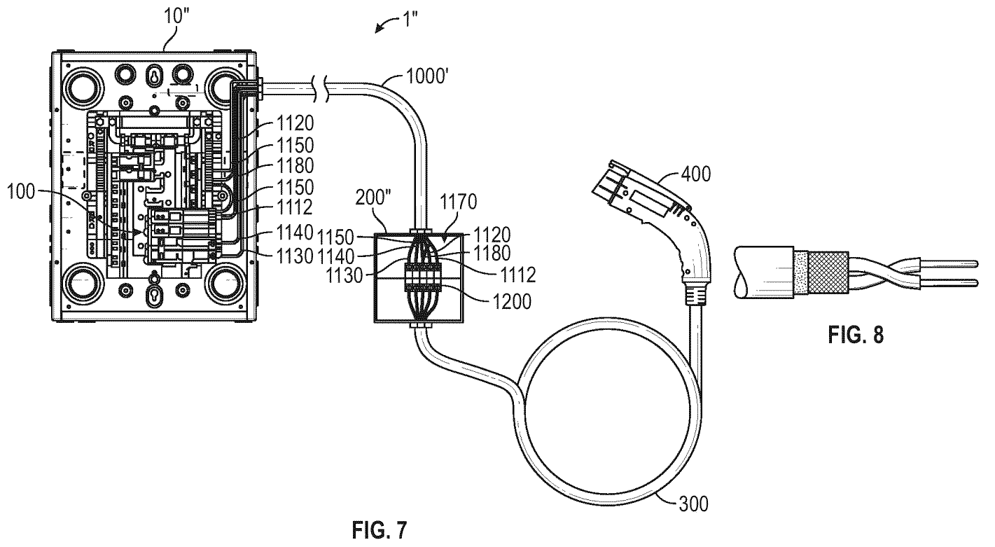

In order to reduce or eliminate the effect of the capacitive coupling to the ground of the CP conductor in the length of the conduit between the EVSE Smart Circuit Breaker Charger and the Junction Box, some example embodiments of the disclosed concept provide an EVSE charging system 1 including a coaxial cable shielded CP conductor 1111 that extends from the EVSE Smart Circuit Breaker Charger 100 to the Junction Box 200 within the conduit 1000 as shown in FIGS. 4, 5, 6 and 6A. Alternatively, some example embodiments of the disclosed concept provide an EVSE charging system 1″ including a shielded twisted pair wiring 1170 consisting of the CP conductor 1112 and the +12 Vdc conductor 1120 as shown in FIGS. 7, 8, 9 and 9A.

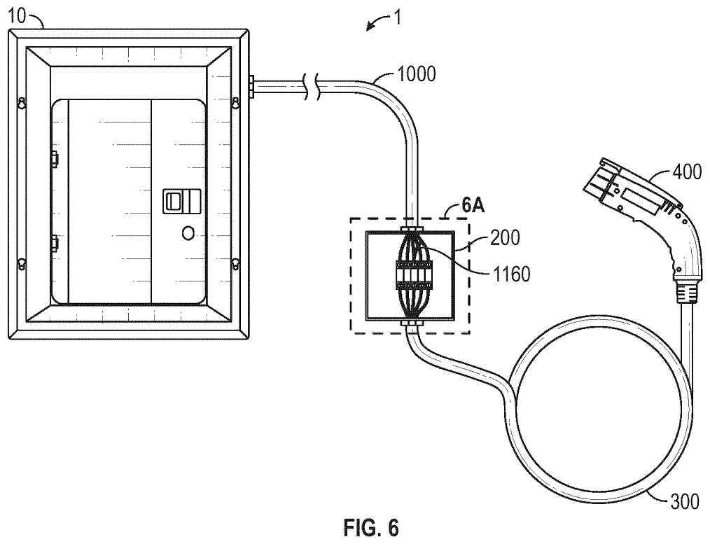

FIGS. 4, 5, 6 and 6A illustrate an EVSE charging system 1 with the EVSE Smart Circuit Breaker Charger 100 electrically connected to a distant Junction Box 200 via a conduit 1000 including a coaxial cable shielded CP conductor 1111. The coaxial cable shielded CP conductor 1111 includes a CP conductor shielded in a coaxial cable, e.g., without example, an RG6 quad shield, dual shield, single shield or any other suitable coaxial cable. An inner view of an exemplary coaxial cable such as the conduit 1000 is illustrated in FIG. 5. A coaxial cable includes an outer jacket, a braided shield, foil shield encasing a dielectric which surrounds a center conductor (e.g., without limitation, the CP conductor). The coaxial cable shielded CP conductor 1111 extends from the EVSE Smart Circuit Breaker Charger 100 disposed within the load center 10 to the terminal blocks 1200 of the Junction Box 200. That is, the coaxial cable carries the CP single ended signal throughout the length of the conduit 1000. The coaxial cable shielded CP conductor 1111 is structured to control (e.g., decouple) CP-ground coupling capacitance and transmit communication and control signals bidirectionally between the EVSE Smart Circuit Breaker Charger 100 and the EV 20 via the EV charge handle 400.

The coaxial cable shielded CP conductor 1111 is further structured to control capacitances between the EVSE Smart Circuit Breaker Charger 100 and the EV 20. For example, the coaxial cable shielded CP conductor 1111 controls the total capacitance within the conduit 1000 to remain within a maximum capacitance threshold. As previously mentioned, the maximum capacitance threshold for the total capacitance is 3100 pF in accordance with the SAE J1772 standard. Controlling the total capacitance to remain within the maximum capacitance threshold allows that the CP communications and control signals are not disrupted, discontinued, or paused. Further, controlling the total capacitance is different from controlling other parameters under the standard. For example, while controlling the total capacitance ensures that the CP communications and control signals are not disrupted or discontinued due to the capacitances resulted from, e.g., without limitation, a metallic conduit 1000 being exposed to moisture or water therein, controlling impedances in the communications circuit for the CP communications and control signals relates to changes to voltages in voltage communications indicating various state of the EVSE charger and the EV. As such, capacitance control resolves a specific problem of ensuring that there be no disruption or discontinuation of the CP communications and control signals whereas impedance control resolves the accuracy of the signals themselves.

The coaxial cable shielded CP conductor 1111 is rated in the same conduit as the power and ground conductors 1130,1140,1150. The conduit 1000 also includes the power conductors 1130,1140 (e.g., without limitation, in an 8AWG cable), ground conductor 1150 (e.g., without limitation, in an 8AWG cable), and +12 Vdc supply conductor 1120 (e.g., without limitation, in an 18AWG cable). The conduit 1000 also includes the coaxial ground shield connection 1160 connected to the ground conductor 1150, thereby grounding one end of the coaxial cable shielding of the CP conductor within the load center 10 and draining any captured capacitances to the ground.

The substantial improvement in the maximum length of the conduit 1000 and/or conductors by providing the coaxial cable shielded CP conductor 1111 in accordance of the disclosed concept is tabulated in Tables 1-4 below. Each table shows experimental results of the maximum allowable length of conduit run for various examples of copper wire gauge, conduit type, and conditions of water flooded conduit that may be encountered with underground or over ground conduit runs.

TABLE 1

| | | Maximum CP wire length | |
|---|---|---|---|
| CP AWG# | Conduit Used | (in Feet) for 3100 pF limit | |
| 18 | PVC | 200 | ft |
| 18 | PVC with water | 56 | ft |
| 18 | EMT | 166 | ft |
| 18 | EMT with water | 25 | ft |
| RG6 Coax | EMT with water | 1788 | ft |

These results demonstrate that various adverse conditions such as flooded conduit and/or the use of larger gauge wire in metallic conduit can reduce the allowable distance to much less than the recommended maximum of 250 ft under the standards. Specifically, shielding the CP conductor 1111 in, e.g., without limitation, quad 18AWG such as an RG6 coaxial cable allows the CP conductor 1111 to extend up to 1,788 ft for 3,100 pF, even if the EMT conduit 1000 includes or is flooded with water/moisture. Table 2 below shows L1, L2 and CP conductor length calculation for 3% voltage drop due to wire resistance (e.g., without limitation, copper wire resistance) at various temperatures in Celsius (C).

TABLE 2
L1 & L2 Wire Length Calculation for 3% Voltage Drop

| | 32 Amp @ | 32 Amp @ | 32 Amp @ | 32 Amp @ |
|---|---|---|---|---|
| | 240 Vac & | 208 Vac & | 240 Vac & | 208 Vac & |
| AWG# | 25 C. | 25 C. | 65 C. | 65 C. |
| 8 | 178 ft | 152 ft | 152 ft | 132 ft |
| 6 | 279 ft | 242 ft | 242 ft | 210 ft |
| 4 | 445 ft | 385 ft | 385 ft | 334 ft |
| 3 | 560 ft | 485 ft | 485 ft | 420 ft |
| 2 | 708 ft | 613 ft | 611 ft | 530 ft |

CP Wire Length Calculation for 3% Voltage Drop

| RG 6 | AWG# 18 CP Line @ 12 milliamp | | |
|---|---|---|---|
| 25 C. | 2304 ft | 65 C. | 1997 ft |

The results in Table 2 show that voltage drop due to Cu wire resistance has been limited to 3% maximum at 32 Amp using the coaxial cable shielded CP conductor 1111 in accordance with the disclosed concept. Further, Table 2 shows that at 25 C an RG6 coaxial shielded CP conductor 1111 may extend the maximum allowable distance thereof to 2,304 ft, which is a substantial increase from the recommended maximum length of 250 ft. These results demonstrate that the use of the proper coaxial cable can extend the allowable range of the CP wire to more than 2000 feet, which results in the maximum allowable run of conduit being governed by voltage drop due to resistance of the primary current conductors L1 and L2 becoming the primary limiting factor in conduit run distance. As such, the maximum allowable lengths of conduit run and the CP conductor between the panel board mounted EVSE Smart Circuit Breaker Charger 100 and the Junction Box 200 connection to the EVSE cord 300 and charge handle 400 can be extended as desired well beyond 250 feet (e.g., without limitation, 279 ft L1 and L2 conductor lengths as shown in Table 2) by using the proper shielded coaxial cable (e.g., without limitation, the inventive coaxial cable shielded CP conductor 1111 or the inventive shielded twisted pair of the CP conductor 1112 of FIGS. 4-6A) and the 12V DC supply conductor 1120 of FIGS. 7-9A) in place of an unshielded single wire conductor for the CP line. Further, the effects of both grounded metallic conduit and the presence of water in flooded underground conduit on CP line capacitance are nullified.

Table 3 shows a plurality of other options to extend the length of the CP line beyond 250 ft.

TABLE 3

| | | | | |
|---|---|---|---|---|
| Recommended | | | | |
| Wire Length | | AWG# for | AWG# for CP | AWG# for LED |
| in Ft | Conduit Type | power (L1, L2) | Conductor | (12 V Conductor) |

Above ground - no water in conduit

| | | | | |
|---|---|---|---|---|
| 150 ft | Non-metallic | 8 | 18 unshielded | 18 unshielded |
| | (PVC) | | | |
| 200 ft | Non-metallic | 6 | 18 unshielded | 18 unshielded |
| 250 ft | Non-metallic | 6 | RG6 shielded | 18 unshielded |
| 400 ft | Non-metallic | 4 | RG6 shielded | 18 unshielded |
| 150 ft | Metallic | 8 | 18 unshielded | 18 unshielded |
| | (EMT) | | | |
| 250 ft | Metallic | 6 | RG6 shielded | 18 unshielded |
| 400 ft | Metallic | 4 | RG6 shielded | 18 unshielded |

Underground - possible water in conduit

| | | | | |
|---|---|---|---|---|
| 24 ft | Any type of | | 18 unshielded | |
| | conduit | | | |
| 150 ft | Any type of | 8 | RG6 shielded | 18 unshielded |
| | conduit | | | |
| 250 ft | Any type of | 6 | RG6 shielded | 18 unshielded |
| | conduit | | | |
| 400 ft | Any type of | 4 | RG6 shielded | 18 unshielded |
| | conduit | | | |

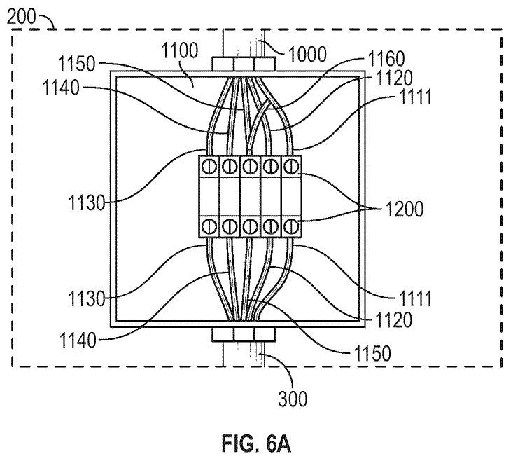

The results in Table 3 are based on a 240 V EVSE charging system. As shown in Table 3, without a coaxial cable shielded CP conductor 1111 (or the shielded twisted pair of the CP conductor 1112 and +12 V DC supply conductor 1120 of FIGS. 6-8A), the allowable length of the CP conductor in an underground (and/or overhead) conduit with possible water therein is merely 24 ft. As such, the improvement in length of any conduit having water or moisture therein is significant, i.e., from mere 24 ft to beyond 250 ft. If an installer chooses to shield the CP line, it is possible to extend beyond what is shown in Table 3. Table 4 shows test data measured using 0.02 meter (¾ inches) EMT, PVC or no conduits. It measures coupling capacitances between the CP conductor and the ground conductor using different conduits. As shown in Table 4, a quad shielded coaxial RG6 CP conductor, when tested at a 150 ft length, has significantly reduced coupling capacitances as compared to those of the conventional, unshielded CP conductor. In addition, a conduit including the inventive coaxial cable shielded CP conductor 1111 (e.g., the quad shielded coaxial RG6 CP conductor as shown in Table 4) has significantly reduced coupling capacitances, e.g., without limitation, 0.003-0.010 nF over a higher frequency of, e.g., without limitation, 3 MHz-30 MHz, which is important for digital communication for smart EV charging. The capacitance remains relatively flat for the higher frequency because the coaxial cable shielded CP conductor 1111 (or the shielded twisted pair of the CP conductor 1112 and +12 V DC supply conductor 1120 of FIGS. 6-8A) controls the coupling capacitances, thereby removing any noises.

TABLE 4

| | | | | | |
|---|---|---|---|---|---|
| Frequency Hz | 100 | 120 | 1K | 10K | 100K |

150 ft AWG#18 Unshielded CP line conductor
to Ground - Bundle in Open Air

| | | | | | |
|---|---|---|---|---|---|
| Capacitance nF | 2.652 | 2.644 | 2.497 | 2.339 | 2.198 |

150 ft AWG#18 Unshielded CP line conductor to
ground - in ¾″ EMT Conduit with Grounding

| | | | | | |
|---|---|---|---|---|---|
| Capacitance nF | 3.816 | 3.784 | 3.495 | 3.262 | 3.092 |

150 ft AWG#18 Unshielded CP line conductor to
ground - in ¾″ EMT Conduit filled with Water, Grounded

| | | | | | |
|---|---|---|---|---|---|
| Capacitance nF | 26.82 | 26.58 | 23.52 | 20.39 | 21.27 |

150 ft AWG#18 Unshielded CP line conductor to
ground - in ¾″ EMT Conduit filled with Water, Not Grounded

| | | | | | |
|---|---|---|---|---|---|
| Capacitance nF | 15.23 | 14.675 | 11.84 | 10.389 | 9.462 |

150 ft Quad Shielded Coaxial RG 6 CP line conductor to
ground - in ¾″ EMT Conduit filled with Water, Grounded,
quad shielded coaxial RG6 Grounded at Both Ends

| Frequency Hz | 100 | 120 | 1K | 10K | 100K | 3 MHz-30 MHz |
|---|---|---|---|---|---|---|
| Capacitance nF | 0.318 | 0.26 | 0.123 | 0.32 | 0.003 | .003-0.010 |

FIGS. 6-8A illustrate an EVSE charging system 1″ with the EVSE Smart Circuit Breaker Charger 100 electrically connected to a Junction Box 200″ via a conduit 1000′ including a shielded twisted pair cable 1170, which consists of a CP conductor 1112 and a +12 Vdc supply conductor 1120. For example, as shown in FIG. 7 the shielded twisted pair cable 1170 includes a cable jacket, a barrier tape, an outer conductor having the CP conductor 1112 and the +12 Vdc supply conductor 1120 encased in respective dielectric cores that in turn extend twisted as a pair throughout the length of the conduit 1000′. The shielded twisted pair CP conductor 1112 is rated in the same conduit as the power and ground conductors 1130,1140,1150. The conduit 1000′ also includes the power conductors 1130,1140 (e.g., without limitation, in an 8AWG cable), ground conductor 1150 (e.g., without limitation, in an 8AWG cable), and +12V DC supply conductor 1120 (e.g., without limitation, in an 18AWG cable). The conduit 1000 also includes the ground shield 1180 connected to the ground conductor 1150.

Therefore, the example embodiments of the disclosed concepts are novel in that utilizing a coaxial cable shield CP conductor 1111 or a shielded twisted pair wiring 1170 in place of single wire conductor for the CP line allows the maximum allowable length of conduit run between the panel board 10,10′,10″ mounted EVSE Smart Circuit Breaker Charger 100 and the Junction Box 200,200′,200″ connection to the EV charge handle 400 to be extended well beyond the current 250 feet limit. Further, the effects of both grounded metallic conduit and the presence of water in flooded underground conduit on CP line capacitance are nullified. Additionally, the example embodiments of the disclosed concepts are also novel in that it allows for a variable extension of distance between the EVSE Smart Circuit Breaker Charger 100 and the EV charging cable and the handle assembly whereas the conventional EVSE utilizes a fixed length charging cable fixed to the EVSE (in North American Standard) or a detachable cable of fixed length that require an auxiliary proximity pilot (PP) line to communicate the maximum allowable current capacity of the cable using resistor logic (in European Standard).

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. An electric vehicle (EV) charging system, comprising:
a load panel including one or more EV supply equipment (EVSE) circuit breaker chargers each comprising an EV charger structured to supply power to an EV via power conductors, a circuit interrupter structured to interrupt current from flowing to the EV in an event of fault, and a communications component structured to transmit bidirectionally control pilot (CP) communications and control signals between the EVSE circuit breaker charger and the EV via a shielded CP conductor and a ground conductor, the shielded CP conductor being structured to control capacitances between the EVSE circuit breaker charger and the EV;
an EV charge handle connected to an EV cord and structured to connect the EVSE circuit breaker charger to the EV for charging;
a conduit structured to encase a plurality of conductors including the power conductors, the shielded CP conductor, the ground conductor, and a 12 V direct current (DC) supply conductor structured to supply power to a status indicator, the plurality of conductors being structured to be electrically connected to the EVSE circuit breaker charger at one end; and
a junction box disposed remotely from the EVSE circuit breaker charger and structured to receive the conduit therein, the junction box including terminal blocks structured to electrically connect the plurality of conductors to the EV charge handle at the other end of the conductors.

2. The EV charging system of claim 1, wherein the shielded CP conductor controls total capacitance within the conduit to remain within a maximum capacitance threshold.

3. The EV charging system of claim 2, wherein the maximum capacitance threshold comprises 3100 pico farad in accordance with SAE J1772 standard and wherein controlling the total capacitance to remain within the maximum capacitance threshold prevents the CP communications and control signals from being disrupted or discontinued.

4. The EV charging system of claim 2, wherein the shielded CP conductor comprises a coaxial cable shielded control pilot (CP) conductor structured to control coupling capacitances between the coaxial cable shielded CP conductor and the ground conductor.

5. The EV charging system of claim 4, wherein the coaxial cable shielded CP conductor has the maximum length that extends beyond 250 feet between the EVSE circuit breaker charger and the terminal blocks of the junction box.

6. The EV charging system of claim 4, wherein the maximum length of the coaxial cable shielded CP conductor is greater than 2000 feet.

7. The EV charging system of claim 4, wherein the conduit comprises a metallic conduit and wherein the coaxial cable shielded CP conductor is structured to nullify capacitive coupling effects of moisture built within the conduit over time and prevent signal distortion on the CP communications and control signals.

8. The EV charging system of claim 3, wherein the conduit further comprises:
a shielded twisted pair of the shielded CP conductor and the 12 V DC supply conductor.

9. The EV charging system of claim 8, wherein the shielded twisted pair allows the maximum length of the CP conductor between the EVSE circuit breaker charger and the terminal blocks to extend beyond 250 feet.

10. The EV charging system of claim 8, wherein the shielded twisted pair of the CP conductor and the 12 V DC supply conductor is structured to nullify capacitive coupling effects of moisture built within the conduit over time and prevent signal distortion on the CP communications and control signals.

11. A conduit structured to electrically connect an electric vehicle supply equipment (EVSE) circuit breaker charger and a junction box coupled to an EV charge handle, the conduit comprising:
a coaxial cable shielded control pilot (CP) conductor structured to transmit bidirectionally CP communications and control signal between the EVSE circuit breaker charger and the EV, the coaxial cable shielded CP conductor being further structured to control capacitances between the EVSE circuit breaker charger and an EV;
power conductors structured to supply power to charge the EV;
a 12 V direct current (DC) supply conductor structured to supply power to a status indicator disposed on the EV charge handle; and
a ground conductor structured to provide a return path for the CP communications and control signal,
wherein the coaxial cable shielded CP conductor, the power conductors, the 12 V DC supply conductor and the ground conductor are electrically connected to the EVSE circuit breaker charger at one end and terminal blocks of the junction box at the other end, the terminal blocks electrically connecting the coaxial cable shielded CP conductor, the power conductors, the 12 V DC supply conductor and the ground conductor to the EV charge handle coupled to an EV cord.

12. The conduit of claim 11, wherein the EVSE circuit breaker charger is disposed in a load panel and comprises an EV charger structured to supply power to the EV via the power conductors, a circuit interrupter structured to interrupt current from flowing to the EV in an event of fault, and a communications component structured to transmit bidirectionally the control pilot (CP) communications and control signals between the EVSE circuit breaker charger and the EV via the coaxial cable shielded CP conductor and the ground conductor; and
wherein the junction box is disposed remotely from the EVSE circuit breaker charger and structured to receive the conduit therein, the junction box including terminal blocks structured to electrically connect the conductors to the EV charge handle at the other end of the conductors.

13. The conduit of claim 12, wherein the shielded CP conductor controls total capacitance within the conduit to remain within a maximum capacitance threshold.

14. The conduit of claim 13, wherein the maximum capacitance threshold comprises 3100 pico farad in accordance with SAE J1772 standard and wherein controlling the total capacitance to remain within the maximum capacitance threshold prevents the CP communications and control signals from being disrupted or discontinued.

15. The conduit of claim 12, wherein the shielded CP conductor comprises a coaxial cable shielded control pilot (CP) conductor structured to control coupling capacitances between the coaxial cable shielded CP conductor and the ground conductor.

16. The conduit of claim 15, wherein the coaxial cable shielded CP conductor has the maximum length that extends beyond 250 feet between the EVSE circuit breaker charger and the terminal blocks of the junction box.

17. The conduit of claim 15, wherein the maximum length of the coaxial cable shielded CP conductor is greater than 2000 feet.

18. The conduit of claim 15, wherein the conduit comprises a metallic conduit and wherein the coaxial cable shielded CP conductor is structured to nullify capacitive coupling effects of moisture built within the conduit over time and prevent signal distortion on the CP communications and control signals.

19. A conduit structured to electrically connect an electric vehicle supply equipment (EVSE) circuit breaker charger and a junction box coupled to an EV charge handle, the conduit comprising:
a shielded twisted pair of a control pilot (CP) conductor and a 12 V direct current (DC) supply conductor, the shielded twisted pair being structured to control capacitances between the EVSE circuit breaker charger and an EV, the CP conductor being structured to transmit bidirectionally CP communications and control signal between the EVSE circuit breaker charger and an EV, the 12 V DC supply conductor structured to supply power to a status indicator disposed on the EV charge handle;
power conductors structured to supply power for charging the EV; and
a ground conductor structured to provide a return path for the CP communications and control signal,
wherein the shielded twisted pair of the CP conductor and the 12 V DC supply conductor, the power conductors, and the ground conductor are electrically connected to the EVSE circuit breaker charger at one end and terminal blocks of the junction box at the other end, the terminal blocks structured to electrically connect the shielded twisted pair of the CP conductor and the 12 V DC supply conductor, the power conductors and the ground conductor to the EV charge handle coupled to an EV cord.

20. The conduit of claim 19, wherein the shielded twisted pair allows the maximum length of the CP conductor between the EVSE circuit breaker charger and the terminal blocks to extend beyond 250 feet, and wherein the shielded twisted pair of the CP conductor and the 12 V DC supply conductor is structured to nullify capacitive coupling effects of moisture built within the conduit over time and prevent signal distortion on the CP communications and control signals.
